(19) United States
(12) Patent Application Publication
(10) Pub. No.: US 2015/0103283 A1
(43) Pub. Date: Apr. 16, 2015

(54) DISPLAY DEVICE

(71) Applicant: Panasonic Liquid Crystal Display Co., Ltd., Himeji-shi (JP)

(72) Inventors: Masahiro ISHII, Osaka (JP); Hiroaki IWATO, Osaka (JP); Daisuke KAJITA, Osaka (JP)

(73) Assignee: Panasonic Liquid Crystal Display Co., Ltd., Himeji-shi (JP)

(21) Appl. No.: 14/199,562

(22) Filed: Mar. 6, 2014

(30) Foreign Application Priority Data
Oct. 15, 2013 (JP) 2013-214444

(51) Int. Cl. G02F 1/1343; G02F 1/1362

(52) U.S. Cl. CPC G02F 1/134309; G02F 1/136286; G02F 2001/134345
USPC 349/46

(57) ABSTRACT

A display device includes a first common bus line electrically connected to common wirings, a second common bus line electrically connected to the first common bus line, and connection wirings for supplying a common voltage to the second common bus line. The second common bus line is divided into a plurality of division wirings. A column direction width of a first division wiring connected to a first connection wiring close to the first common bus line is smaller than a column direction width of a second division wiring connected to a second connection wiring far from the first common bus line.

### CROSS-REFERENCE TO RELATED APPLICATION

The present application claims priority from Japanese application JP 2013-214444 filed on Oct. 15, 2013, the content of which is hereby incorporated by reference into this application.

### TECHNICAL FIELD

The present application relates to a display device, and more particularly, to a wiring for supplying a common voltage to a common electrode.

### BACKGROUND

Among various types of display devices, a liquid crystal display device, for example, is configured to display an image by applying, to liquid crystal, an electric field generated between a pixel electrode formed in each pixel region and a common electrode to drive the liquid crystal, thereby adjusting an amount of light passing through a region between the pixel electrode and the common electrode. The common electrode is supplied with a common voltage from an external circuit via a common bus line.

Japanese Patent Application Laid-open No. 2005-157404 discloses a structure for supplying a common voltage to the common electrode. Specifically, in a liquid crystal display device disclosed in Japanese Patent Application Laid-open No. 2005-157404, the common bus line is disposed on one side surface side of a display panel, and the common bus line is connected to each common wiring (opposed voltage signal line) extending in the same direction as the gate signal line. Further, the common voltage supplied from the external circuit to the common bus line is supplied to each common electrode via each common wiring.

### SUMMARY

However, in the structure disclosed in Japanese Patent Application Laid-open No. 2005-157404, it is difficult to stably supply electric power (common voltage) to the common electrode particularly in a high definition display device. Then, when a desired common voltage cannot be stably supplied to the common electrode, there occurs a problem in that display quality is deteriorated.

The present invention has been made in view of the above-mentioned circumstances, and it is an object thereof to provide a display device capable of stably supplying a common voltage to a common electrode.

In order to solve the above-mentioned problem, according to one embodiment of the present application, there is provided a display device, including: a plurality of gate signal lines each extending in a row direction; a plurality of data signal lines each extending in a column direction; a plurality of pixel regions arranged in the row direction and in the column direction in an image display region; a pixel electrode formed in each of the plurality of pixel regions; a common electrode formed in the image display region; a plurality of common wirings extending in the row direction, for supplying a common voltage to the common electrode; a first common bus line extending along an outer edge in the column direction of the image display region at a position outside the image display region, the first common bus line being electrically connected to the plurality of common wirings; a second common bus line extending along an outer edge in the row direction of the image display region at a position outside the image display region, the second common bus line being electrically connected to the first common bus line; and a plurality of connection wirings arranged in the row direction at positions outside the image display region, for supplying the common voltage to the second common bus line, in which: the second common bus line is divided into a plurality of division wirings by a plurality of slits; the plurality of connection wirings include: a first connection wiring; and a second connection wiring disposed at a position farther from the first common bus line in the row direction than the first connection wiring; the plurality of division wirings include: a first division wiring connected to the first connection wiring; and a second division wiring connected to the second connection wiring; and a column direction width of the first division wiring is smaller than a column direction width of the second division wiring.

In the display device according to one embodiment of the present application, it is preferred that the first division wiring and the second division wiring be formed in an L-shape, and that a row direction width of the first division wiring at an end connected to the first connection wiring be equal to a row direction width of the second division wiring at an end connected to the second connection wiring.

In the display device according to one embodiment of the present application, ends of the plurality of division wirings connected to the first common bus line may be coupled to each other.

In the display device according to one embodiment of the present application, the first common bus line and the second common bus line may be electrically connected to each other via a metal wiring.

In the display device according to one embodiment of the present application, the first common bus line and the second common bus line may be formed in different layers.

In the display device according to one embodiment of the present application, the first common bus line may be formed in the same layer as the plurality of data signal lines, and the second common bus line may be formed in the same layer as the plurality of gate signal lines.

In the display device according to one embodiment of the present application, the first common bus line, the second common bus line, and the common electrode may be formed in the same layer.

In the display device according to one embodiment of the present application, it is preferred that the first common bus line be first common bus lines disposed on both sides of the image display region, and that the second common bus line be second common bus lines disposed in a line-symmetric manner with respect to a center line in the row direction of the image display region.

In order to solve the above-mentioned problem, according to one embodiment of the present application, there is provided a display device, including: a plurality of gate signal lines each extending in a row direction; a plurality of data signal lines each extending in a column direction; a plurality of pixel regions arranged in the row direction and in the column direction in an image display region; a pixel electrode formed in each of the plurality of pixel regions; a common electrode formed in the image display region; a plurality of common wirings extending in the row direction, for supplying a common voltage to the common electrode; a first common bus line extending along an outer edge in the column direction of the image display region at a position outside the image display region, the first common bus line being electrically connected to the plurality of common wirings; a second common bus line extending along an outer edge in the row direction of the image display region at a position outside the image display region, the second common bus line being electrically connected to the first common bus line; and a plurality of connection wirings arranged in the row direction at positions outside the image display region, for supplying the common voltage to the second common bus line, in which: the second common bus line includes a plurality of division wirings; and wiring resistances of the plurality of division wirings are substantially equal to each other in a region of from a connection portion between the plurality of division wirings and the first common bus line to a connection portion between the plurality of division wirings and the plurality of connection wirings.

### BRIEF DESCRIPTION OF THE DRAWINGS

FIG. 1 is a diagram illustrating an overall structure of a liquid crystal display device according to an embodiment of the present application.

FIG. 2 is a plan view of one pixel in the liquid crystal display device illustrated in FIG. 1.

FIG. 3 is a cross-sectional view taken along the line 3-3′ of the pixel illustrated in FIG. 2.

FIG. 4 is a cross-sectional view taken along the line 4-4′ of the pixel illustrated in FIG. 2.

FIG. 5 is a plan view illustrating a structure of a second common bus line.

FIG. 6 is a table showing an example of the structure of the second common bus line.

FIG. 7 is a cross-sectional view illustrating an example of a connection portion between a division wiring and a connection wiring.

FIG. 8 is a cross-sectional view illustrating another example of the connection portion between the division wiring and the connection wiring.

FIG. 9 is a cross-sectional view illustrating an example of a connection portion between a first common bus line and the second common bus line.

FIG. 10 is a cross-sectional view illustrating another example of the connection portion between the first common bus line and the second common bus line.

FIG. 11 is a plan view illustrating another structure of the second common bus line.

FIG. 12 is a plan view illustrating another structure of the second common bus line.

FIG. 13 is a plan view illustrating another structure of the second common bus line.

### DETAILED DESCRIPTION

An embodiment of the present application is described below with reference to the accompanying drawings. In the following embodiment, a liquid crystal display device is taken as an example, but a display device according to the present invention is not limited to the liquid crystal display device, and may be, for example, an organic EL display device.

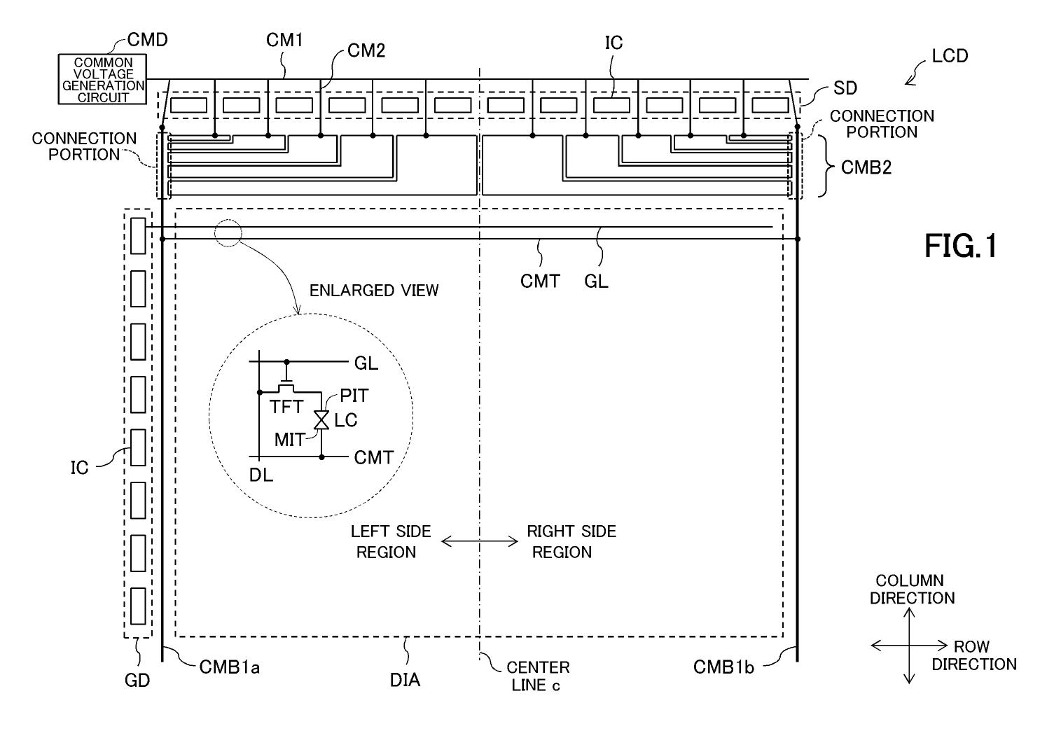

FIG. 1 is a diagram illustrating an overall structure of a liquid crystal display device according to the embodiment of the present application. A liquid crystal display device LCD includes an image display region DIA and a drive circuit region around the image display region DIA. In the image display region DIA, a plurality of pixel regions, each of which is surrounded by two neighboring gate signal lines GL and two neighboring data signal lines DL, are arranged in a row direction and in a column direction like a matrix. A direction in which the gate signal line GL extends is the row direction, and a direction in which the data signal line DL extends is the column direction.

In each pixel region, a pixel electrode PIT and a common electrode MIT are formed. In addition, a thin film transistor TFT is formed in a vicinity of an intersection of the gate signal line GL and the data signal line DL in each pixel region. The pixel electrode PIT is connected to the data signal line DL via the thin film transistor TFT. The common electrode MIT is connected to a common wiring CMT. The common wiring CMT is formed to extend in the row direction similarly to the gate signal line GL and disposed in each pixel region. The common electrode MIT may be formed for each pixel region separately or may be solidly formed in the entire image display region DIA. In addition, the common electrode MIT may have slits (aperture portions) formed in each pixel region.

In the drive circuit region, there are formed a data line drive circuit SD, a gate line drive circuit GD, a common voltage generation circuit CMD, and a control circuit (not shown). These drive circuits may be mounted on a display panel or may be mounted on a circuit board disposed outside the display panel. The data line drive circuit SD includes a plurality of data drivers IC disposed at regular intervals. Each data driver IC is connected to a plurality of data signal lines DL. The gate line drive circuit GD includes a plurality of gate drivers IC disposed at regular intervals, and each gate driver IC is connected to a plurality of gate signal lines GL.

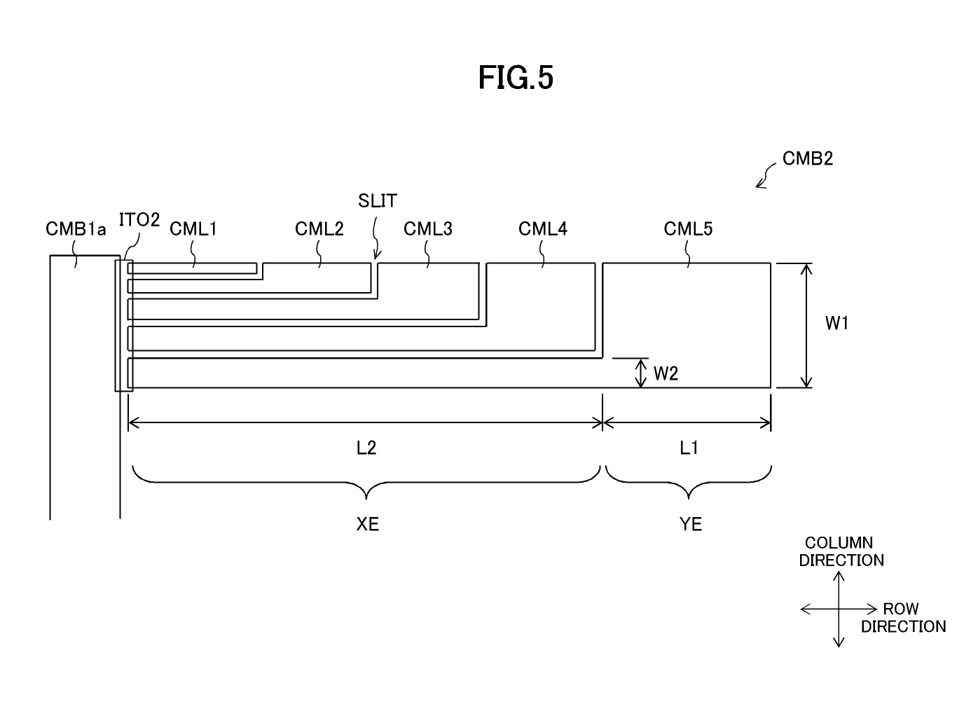

The common voltage generation circuit CMD is connected to a single or a plurality of lead wirings CM1 extending in the row direction. The lead wiring CM1 is connected to one end of each of a plurality of connection wirings CM2 arranged in the row direction. Each connection wiring CM2 extends in the column direction and is disposed in a region between two neighboring data drivers IC in plan view. The other end of each connection wiring CM2 is connected to a second common bus line CMB2. The second common bus line CMB2 extends along the outer edge in the row direction of the image display region DIA at a position outside the image display region DIA. In addition, the second common bus line CMB2 is divided into a plurality of division wirings CML (see FIG. 5). Specifically, the second common bus line CMB2 is divided into right and left regions at the center (at a center line c in the row direction of the display panel) by a slit in the column direction. Further, each of the right and left regions of the divided second common bus line CMB2 is divided into the plurality of L-shaped division wirings CML by a plurality of L-shaped slits including a plurality of slits arranged in the row direction and having different lengths in the column direction, and a plurality of slits having different lengths in the row direction and extending from the ends of the above-mentioned slits. In addition, the plurality of division wirings CML (five division wirings CML in FIG. 1) disposed in the left side region and the plurality of division wirings CML (five division wirings CML in FIG. 1) disposed in the right side region are formed in a line-symmetric manner with respect to the center line c. Each division wiring CML is electrically connected to each connection wiring CM2. In other words, one division wiring CML is electrically connected to one connection wiring CM2.

A side end of the second common bus line CMB2, that is, a left end of each division wiring CML in the left side region is electrically connected to a first common bus line CMB1a formed in the left side surface of the display panel at a connection portion. In addition, a right end of each division wiring CML in the right side region is electrically connected to a first common bus line CMB1b formed in the right side surface of the display panel at a connection portion. The first common bus lines CMB1a and CMB1b extend along the outer edges in the column direction of the image display region DIA at positions outside the image display region DIA. The first common bus lines CMB1a and CMB1b are electrically connected to the plurality of common wirings CMT. In other words, a left end of each common wiring CMT is electrically connected to the left side first common bus line CMB1a, while a right end of each common wiring CMT is electrically connected to the right side first common bus line CMB1b. Thus, the common voltage output from the common voltage generation circuit CMD is supplied to each common wiring CMT via the lead wiring CM1, the connection wiring CM2, the second common bus line CMB2 (plurality of division wirings CML), and the first common bus line CMB1 (CMB1a, CMB1b). The common voltage supplied to each common wiring CMT is supplied to each common electrode MIT. Further, the connection wirings CM2 disposed on both end sides of the display panel are connected to the first common bus lines CMB1a and CMB1b without using the second common bus line CMB2 therebetween. A specific structure of the second common bus line CMB2 is described later.

In each pixel region, active matrix display is performed. Specifically, the gate line drive circuit GD supplies a gate voltage to the gate signal line GL, and the data line drive circuit SD supplies a data voltage to the data signal line DL. When the thin film transistor TFT is turned ON and OFF by the gate voltage, the data voltage is supplied to the pixel electrode PIT . When a liquid crystal layer LC is driven by an electric field generated by a difference between the data voltage supplied to the pixel electrode PIT and the common voltage supplied from the common voltage generation circuit CMD to the common electrode MIT, light transmittance in each pixel region is controlled so that image display is performed. Further, when color display is performed, desired data voltages are applied to data signal lines DL(R), DL(G), and DL (B) connected to the pixel electrodes PIT in pixel regions corresponding to red (R), green (G), and blue (B) that are formed by vertical stripe color filters. In this manner, the color display is realized.

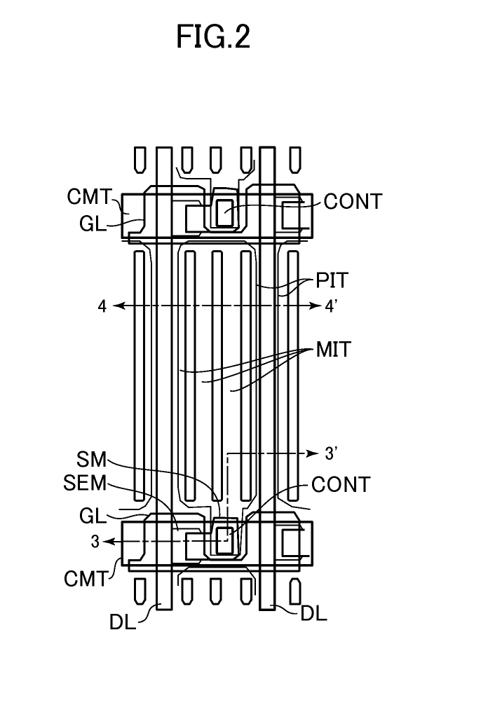

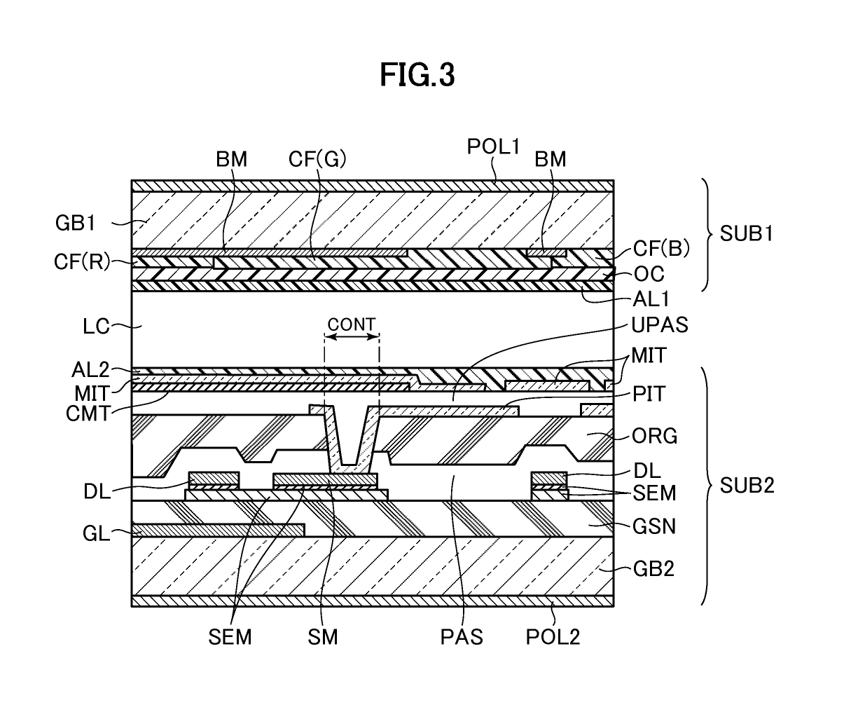

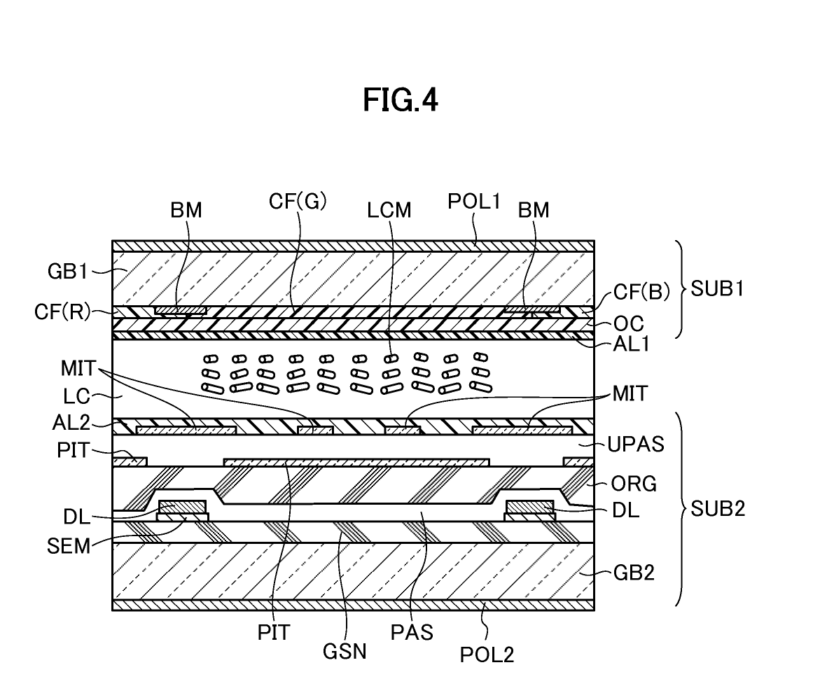

FIG. 2 is a plan view illustrating a structure of one pixel region. FIG. 2 illustrates a planar pattern of a rear side TFT substrate SUB2. FIG. 3 is a cross-sectional view taken along the line 3-3′ in FIG. 2, and FIG. 4 is a cross-sectional view taken along the line 4-4′ in FIG. 2.

The liquid crystal display device LCD includes a CF substrate SUB1 on a display surface side, the rear side TFT substrate SUB2, and the liquid crystal layer LC sandwiched between the both substrates.

In the TFT substrate SUB2, a gate insulating film GSN is formed so as to cover the gate signal line GL formed on a glass substrate GB2, and a semiconductor layer SEM is formed on the gate insulating film GSN. On the semiconductor layer SEM, the data signal line DL and a source electrode SM of the thin film transistor TFT are formed. An insulating film PAS is formed so as to cover the data signal line DL and the source electrode SM, and an organic insulating film ORG is formed on the insulating film PAS.

In a region above the source electrode SM for extracting the data voltage from the semiconductor layer SEM, a contact hole CONT is formed in the insulating film PAS and the organic insulating film ORG. The pixel electrode PIT is formed on the organic insulating film ORG and in the contact hole CONT. An upper layer insulating film UPAS is formed so as to cover the pixel electrode PIT. On the upper layer insulating film UPAS, the common wiring CMT is formed so as to overlap the gate signal line GL in plan view (as viewed from the display surface side). The common wiring CMT extends in the same direction as the gate signal line GL (in the row direction).

As illustrated in FIG. 3, on the common wiring CMT, a part of the common electrode MIT is formed in an overlapping manner. In this way, the common wiring CMT and the common electrode MIT are electrically connected to each other. Further, the common electrode MIT may be formed on the upper layer insulating film UPAS, and the common wiring CMT may be formed on the common electrode MIT. As illustrated in FIG. 2, the common electrode MIT has slits (aperture portions) formed in one pixel region. The shape of the slit of the common electrode MIT is not limited particularly, and the shape may be an elongated shape or may be a rectangular shape, an elliptic shape, or the like. Further, the organic insulating film ORG illustrated in FIG. 3 may be omitted. An alignment film AL2 is formed on the common electrode MIT.

In the CF substrate SUB1, a black matrix BM and colored portions CF are formed on a glass substrate GB1, and an overcoat layer OC is formed so as to cover the black matrix BM and the colored portions CF. An alignment film AL1 is formed on the overcoat layer OC.

Positive liquid crystal molecules LCM having major axes aligned in the electric field direction (see FIG. 4) are encapsulated in the liquid crystal layer LC. Polarizing plates POL1 and POL2 are bonded to the outsides of the CF substrate SUB1 and the TFT substrate SUB2, respectively.

With the structure illustrated in FIGS. 2 to 4, the liquid crystal display device LCD has a so-called in-plane switching (IPS) structure. However, the display device according to the present invention is not limited to this structure. In addition, layer positions of the pixel electrode PIT and the common electrode MIT are not limited to those in the structure described above. For instance, it is possible to adopt a structure in which the common wiring CMT and the common electrode MIT are formed on the organic insulating film ORG, the upper layer insulating film UPAS is formed so as to cover the common wiring CMT and the common electrode MIT, and the pixel electrode PIT is formed on the upper layer insulating film UPAS.

As described above, in this liquid crystal display device LCD, the common voltage output from the common voltage generation circuit CMD is supplied to the common electrode MIT via the plurality of connection wirings CM2 and the plurality of division wirings CML. Here, each wiring electrically connected to the common electrode MIT has a wiring resistance. When a wiring thickness is constant, the wiring resistance depends on a length and a width of the wiring. Therefore, when the second common bus line CMB2 is not divided into the plurality of division wirings CML but is formed as one wiring, for example, a wiring resistance of the second common bus line CMB2 is smaller at a portion at which a distance from the first common bus lines CMB1a and CMB1b to the connection portion (connection terminal) between the second common bus line CMB2 and the connection wiring CM2 is shorter. Thus, a current is concentrated in a connection terminal closer to the first common bus lines CMB1a and CMB1b among the connection terminals between the second common bus line CMB2 and the connection wirings CM2, and hence the connection terminal may be burned out.

In contrast, in this liquid crystal display device LCD, the second common bus line CMB2 is divided so that the wiring resistances of the plurality of division wirings CML become uniform. In this way, the currents supplied to the connection terminals are made uniform, and hence it is possible to prevent the burnout of the connection terminal due to the concentration of current. Therefore, it is possible to stably supply the common voltage to the common electrode. In the following description, a specific structure of each division wiring CML in the second common bus line CMB2 is described.

FIG. 5 is a plan view illustrating a structure of the second common bus line CMB2. FIG. 5 illustrates division wirings CML1 to CML5 in the left side region of the second common bus line CMB2. Further, FIG. 5 also illustrates a metal wiring ITO2 (described later) connecting the division wirings CML1 to CML5 to the first common bus line CMB1a. The division wirings CML in the right side region of the second common bus line CMB2 have the same (line-symmetric) structure as the division wirings CML1 to CML5, and therefore description thereof is omitted.

The second common bus line CMB2 is divided into the division wirings CML1 to CML5 by the L-shaped slits including the slits in the column direction and the slits in the row direction. Each of the division wirings CML2 to CML5 includes a column extending portion YE having a row direction width L1 and a column direction width W1, and a row extending portion XE having a row direction width L2 and a column direction width W2, so as to have an L shape. Further, both the width L2 and the width W2 are zero in the division wiring CML1, and only the column extending portion YE constitutes the division wiring CML1.

The division wirings CML1 to CML5 have substantially the same width L1. The division wirings CML1 to CML5 are connected to the connection wirings CM2 (see FIG. 1). The connection wirings CM2 are laid between the data drivers IC disposed at regular intervals, and hence it is preferred that the widths L1 of the division wirings CML1 to CML5 connected to the respective connection wirings CM2 be also substantially the same. Further, the widths L1 of the division wirings CML1 to CML5 are regarded to be substantially the same when a difference between each of the widths L1 and an average value of the widths L1 is within a range of ±10% of the average value. In addition, the width W2 of each of the division wirings CML1 to CML5 is larger as a position of the column extending portion YE in the row direction is farther from the first common bus line CMB1a (as the width L2 of the row extending portion XE is larger). In other words, the column direction widths W1 and W2 of the division wirings CML1 to CML5 are larger as a distance in the row direction from the first common bus line CMB1a to the connection wiring CM2 connected to each division wiring is larger. In other words, when focusing on the first division wiring CML connected to the first connection wiring CM2 and the second division wiring CML connected to the second connection wiring CM2 disposed at the farther position in the row direction from the first common bus line CMB1a than the first connection wiring CM2 among the plurality of division wirings CML, the column direction widths W1 and W2 of the first division wiring CML are smaller than the column direction widths W1 and W2 of the second division wiring CML. From the above description, the width L2 and the widths W1 and W2 of the division wirings CML can be expressed by the following relational expressions.

L2 (CML1)<L2 (CML2)<L2 (CML3)<L2 (CML4)<L2 (CML5)

W1 (CML1)<W1 (CML2)<W1 (CML3)<W1 (CML4)<W1 (CML5)

W2 (CML1)<W2 (CML2)<W2 (CML3)<W2 (CML4)<W2 (CML5)

In addition, the widths L1, L2, W1, and W2 of the division wirings CML1 to CML5 satisfy the following relational expression so that wiring resistances R of the division wirings CML are substantially equal to each other. Further, a coefficient C indicates a sheet resistance. The widths L1, L2, W1, and W2 of the division wirings CML1 to CML5 may be set so that the wiring resistances R of the division wirings CML become equal to each other or that a difference between the wiring resistance R of each division wiring CML and an average value of the wiring resistances R is within a range of ±10% of the average value. In other words, when the difference between the wiring resistance R of each division wiring

CML and the average value of the wiring resistances R is within the range of ±10% of the average value, the wiring resistances R of the division wirings CML are regarded to be substantially equal to each other.

R=(L1/W1+L2/W2)×C (1)

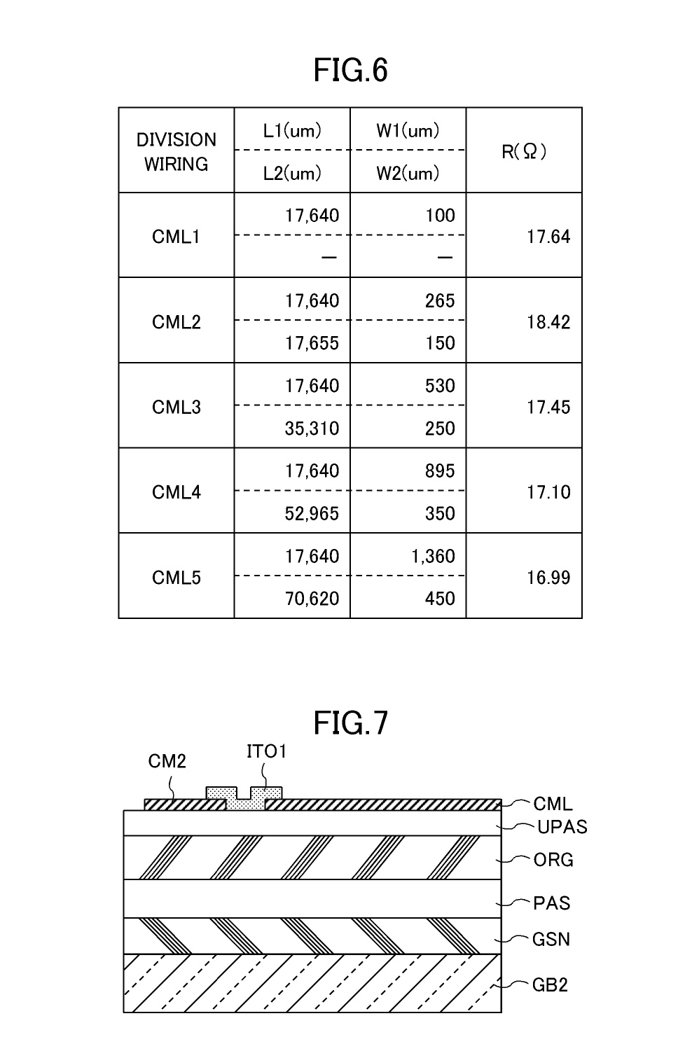

FIG. 6 shows an example of the widths L1, L2, W1, and W2 of the division wirings CML1 to CML5, and the wiring resistance R (Ω) calculated based on the widths L1, L2, W1, and W2. Further, in FIG. 6, the coefficient C in Expression (1) is 0.1 (Ω/square) as a sheet resistance of a copper (Cu) wiring. In addition, a distance between neighboring division wirings CML is 15 μm. As shown in FIG. 6, it is understood that the difference between the wiring resistance R of each division wiring CML and the average value of the wiring resistances R (=17.52 Ω) is within the range of ±10% (=±1.75) of the average value so that the wiring resistances R of the division wirings CML are substantially equal to each other.

In this way, according to the liquid crystal display device LCD of this embodiment, the wiring resistances R of the division wirings CML are substantially equal to each other, and therefore the common voltages applied to the common electrodes MIT can be equalized. In addition, the wiring resistances R of the division wirings CML are substantially equal to each other, and hence it is possible to prevent the burnout of the connection terminal due to the concentration of current. Specifically, the currents flowing in the connection portions between the division wirings CML and the connection wirings CM2 and the currents flowing in the connection portions between the division wirings CML and the first common bus lines CMB1a and CMB1b are equalized, and hence it is possible to prevent the burnout of the connection terminal due to the concentration of current. Therefore, it is possible to stably supply the common voltage output from the common voltage generation circuit CMD to the common electrode MIT so that deterioration of display quality due to the wiring resistance can be prevented.

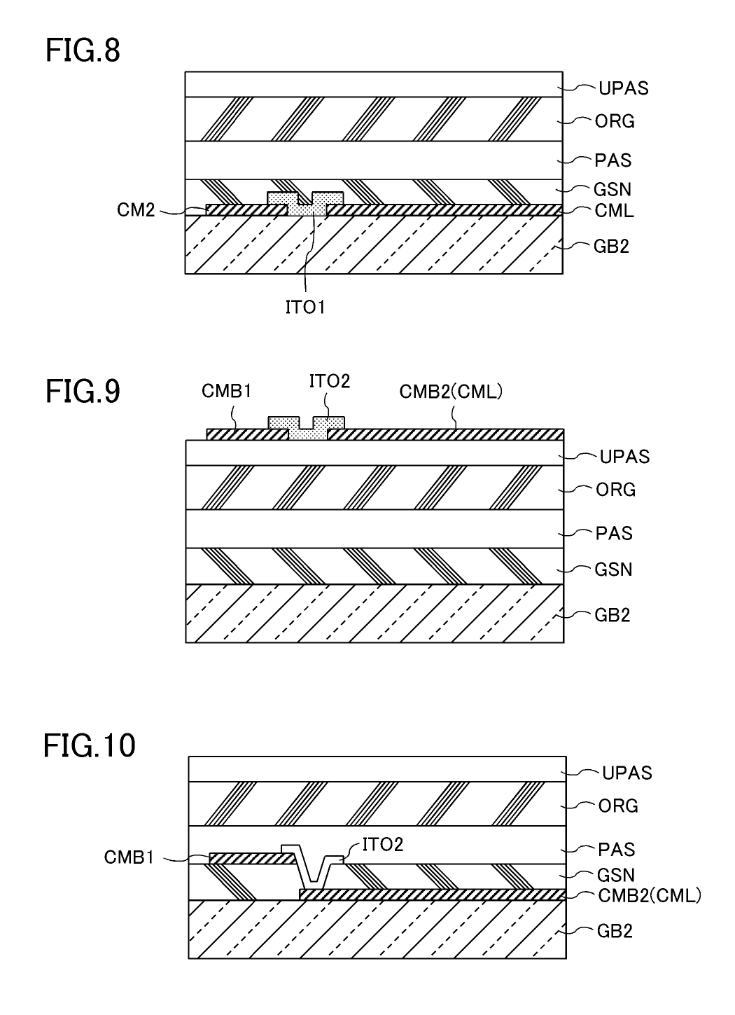

A specific example of a cross-sectional structure of the connection portion is described below. FIG. 7 is a cross-sectional view illustrating the connection portion between the division wiring CML and the connection wiring CM2. In the example illustrated in FIG. 7, the division wiring CML and the connection wiring CM2 are formed on the upper layer insulating film UPAS, and are electrically connected by a metal wiring ITO1 made of indium tin oxide (ITO) and covering ends of the division wiring CML and the connection wiring CM2. Further, as illustrated in FIG. 8, the division wiring CML and the connection wiring CM2 may be formed on a gate layer, that is, the glass substrate GB2.

FIG. 9 is a cross-sectional view illustrating a connection portion between the first common bus line CMB1 and the second common bus line CMB2 (division wiring CML). In the example illustrated in FIG. 9, the first common bus line CMB1 and the second common bus line CMB2 are formed on the upper layer insulating film UPAS and are electrically connected by the metal wiring ITO2 (see FIG. 5) made of ITO and covering ends of the first common bus line CMB1 and the second common bus line CMB2. Further, as illustrated in FIG. 10, the second common bus line CMB2 may be formed on the gate layer (on the glass substrate GB2) (see FIG. 8), and the first common bus line CMB1 may be formed on a source/drain layer (on the gate insulating film GSN). Here, the first common bus line CMB1 and the second common bus line CMB2 may be integrally formed, but it is preferred that the first common bus line CMB1 and the second common bus line CMB2 be formed separately and be electrically connected to each other via the metal wiring ITO2 as illustrated in FIG. 9 and FIG. 10. In this way, it is possible to avoid an influence of abnormal discharge due to static electricity or the like generated in a manufacturing process.

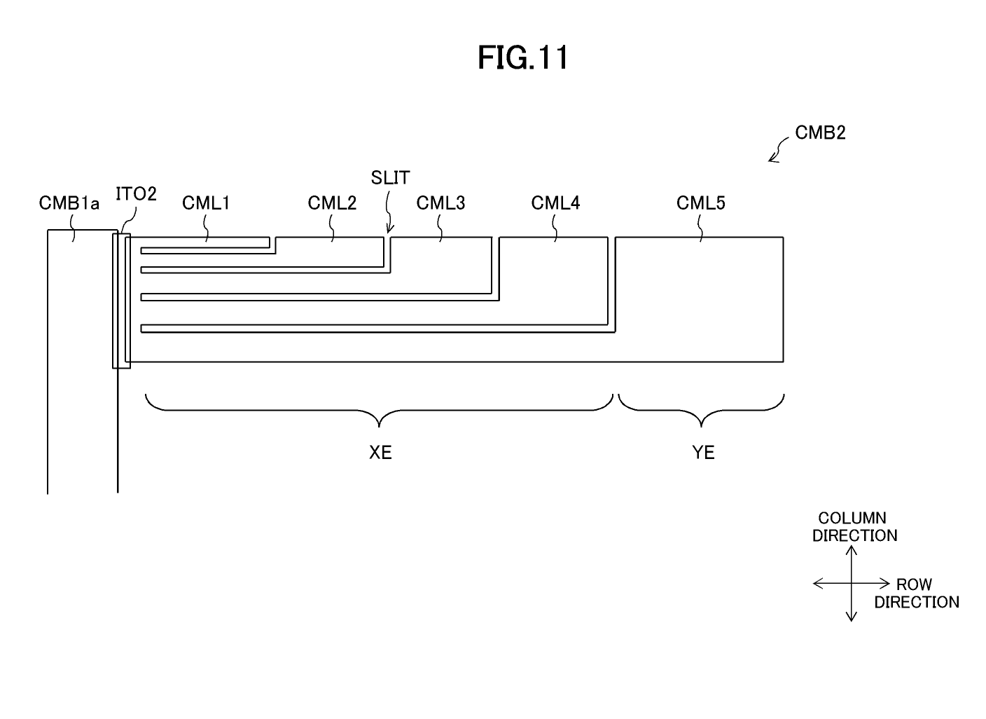

The division wirings CML1 to CML5 are separately formed in the second common bus line CMB2 illustrated in FIG. 5, but the present invention is not limited to this structure. For instance, as illustrated in FIG. 11, ends of the division wirings CML1 to CML5 on the first common bus line CMB1 side may be coupled to each other (for example, may be formed integrally). In this way, the concentration of current in the connection portion between the division wirings CML1 to CML5 and the first common bus lines CMB1a and CMB1b can be avoided. Therefore, the burnout of the connection terminal due to the concentration of current can be prevented. The row direction width of the coupling portion at the end of the second common bus line CMB2 can be 250 μm, for example. Further, FIG. 11 also illustrates the metal wiring ITO2 connecting the first common bus line CMB1 and the second common bus line CMB2.

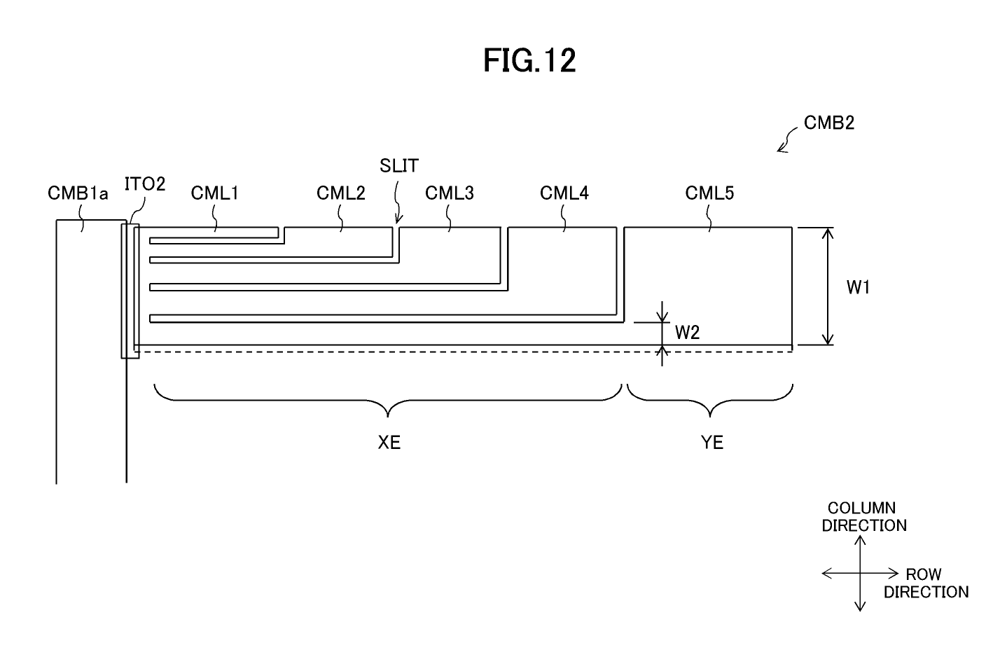

The present invention is not limited to the embodiment described above. For instance, the division wiring CML5 disposed at the position closest to the image display region DIA may be directly connected to the common electrode MIT in the image display region DIA. In this case, the current flowing in the common electrode MIT is increased compared with the structure illustrated in FIG. 5. Therefore, as illustrated in FIG. 12, it is preferred to set the widths W1 and W2 of the division wiring CML5 to be smaller than the widths W1 and W2 (dotted line portion in FIG. 12) in the structure illustrated in FIG. 5. In this way, the wiring resistance R of the division wiring CML5 becomes larger than the wiring resistance R in the structure illustrated in FIG. 5. Therefore, the common voltage applied to the common electrode MIT can be made close to the common voltage in the structure illustrated in FIG. 5. In addition, according to the structure of FIG. 12, the wiring widths W1 and W2 in the column direction can be reduced, and therefore a narrower frame can be achieved.

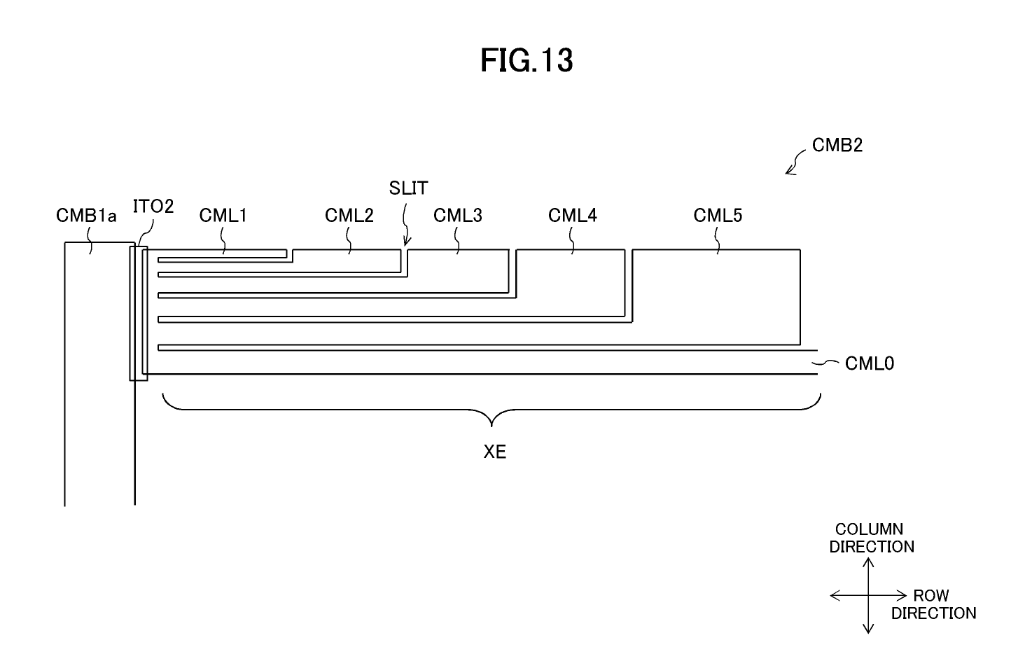

FIG. 13 is a plan view illustrating another structure of the second common bus line CMB2. In the structure illustrated in FIG. 13, a division wiring CML0 disposed at the position closest to the image display region DIA includes only the row extending portion XE and extends from the left side first common bus line CMB1a to the right side first common bus line CMB1b linearly in the row direction. In addition, the division wiring CML0 is separated from the connection wiring CM2 and is electrically connected to the connection wiring CM2 via the coupling portion at the end of the second common bus line CMB2. Further, the division wiring CML0 is directly connected to the common electrode MIT in the image display region DIA.

In the embodiment described above, the row direction widths L1 and L2, and the column direction widths W1 and W2 of the plurality of division wirings CML constituting the second common bus line CMB2 for electrically connecting the connection wirings CM2 and the first common bus line CMB1 to each other are adjusted so that the wiring resistances thereof become substantially equal to each other. However, the present invention is not limited to this structure. The widths, lengths, and thicknesses of the division wirings CML may be substantially equalized so that the wiring resistances thereof become substantially equal to each other. For instance, the division wiring CML connected to the connection wiring CM2 disposed at a position close to the first common bus line CMB1 in the row direction is connected to the first common bus line CMB1 via a bypass (not shown), and the division wiring CML connected to the connection wiring CM2 disposed at a position far from the first common bus line CMB1 in the row direction is connected to the first common bus line CMB1 without a bypass therebetween. Further, the bypass is disposed in a frame region outside the image display region DIA, for example. In this way, the respective wiring resistances are substantially equal to each other. In addition, the wiring resistances of the division wirings CML may be substantially equalized to each other by varying not only the widths L1, L2, W1, and W2 but also the thicknesses thereof. Further, the wiring resistances of the division wirings CML may be substantially equalized to each other by varying materials of the division wirings CML.

According to the structure of the liquid crystal display device according to the embodiment described above, the common voltage is supplied to the common electrode via the plurality of connection wirings and division wirings. In addition, the wiring resistances of the plurality of division wirings can be substantially equal to each other. Therefore, the common voltage can be stably supplied to the common electrode.

While there have been described what are at present considered to be certain embodiments of the application, it will be understood that various modifications may be made thereto, and it is intended that the appended claims cover all such modifications as fall within the true spirit and scope of the invention.

What is claimed is:

1. A display device, comprising:
a plurality of gate signal lines each extending in a row direction;
a plurality of data signal lines each extending in a column direction;
a plurality of pixel regions arranged in the row direction and in the column direction in an image display region;
a pixel electrode formed in each of the plurality of pixel regions;
a common electrode formed in the image display region;
a plurality of common wirings extending in the row direction, for supplying a common voltage to the common electrode;
a first common bus line extending along an outer edge in the column direction of the image display region at a position outside the image display region, the first common bus line being electrically connected to the plurality of common wirings;
a second common bus line extending along an outer edge in the row direction of the image display region at a position outside the image display region, the second common bus line being electrically connected to the first common bus line; and
a plurality of connection wirings arranged in the row direction at positions outside the image display region, for supplying the common voltage to the second common bus line, wherein:
the second common bus line is divided into a plurality of division wirings by a plurality of slits;
the plurality of connection wirings comprise:
a first connection wiring; and
a second connection wiring disposed at a position farther from the first common bus line in the row direction than the first connection wiring;
the plurality of division wirings comprise:
a first division wiring connected to the first connection wiring; and
a second division wiring connected to the second connection wiring; and
a column direction width of the first division wiring is smaller than a column direction width of the second division wiring.

2. The display device according to claim 1, wherein:
the first division wiring and the second division wiring are formed in an L-shape; and
a row direction width of the first division wiring at an end connected to the first connection wiring is equal to a row direction width of the second division wiring at an end connected to the second connection wiring.

3. The display device according to claim 1, wherein ends of the plurality of division wirings connected to the first common bus line are coupled to each other.

4. The display device according to claim 1, wherein the first common bus line and the second common bus line are electrically connected to each other via a metal wiring.

5. The display device according to claim 1, wherein the first common bus line and the second common bus line are formed in different layers.

6. The display device according to claim 5, wherein the first common bus line is formed in the same layer as the plurality of data signal lines, and the second common bus line is formed in the same layer as the plurality of gate signal lines.

7. The display device according to claim 1, wherein the first common bus line, the second common bus line, and the common electrode are formed in the same layer.

8. The display device according to claim 1, wherein:
the first common bus line comprises first common bus lines disposed on both sides of the image display region; and
the second common bus line comprises second common bus lines disposed in a line-symmetric manner with respect to a center line in the row direction of the image display region.

9. A display device, comprising:
a plurality of gate signal lines each extending in a row direction;
a plurality of data signal lines each extending in a column direction;
a plurality of pixel regions arranged in the row direction and in the column direction in an image display region;
a pixel electrode formed in each of the plurality of pixel regions;
a common electrode formed in the image display region;
a plurality of common wirings extending in the row direction, for supplying a common voltage to the common electrode;
a first common bus line extending along an outer edge in the column direction of the image display region at a position outside the image display region, the first common bus line being electrically connected to the plurality of common wirings;
a second common bus line extending along an outer edge in the row direction of the image display region at a position outside the image display region, the second common bus line being electrically connected to the first common bus line; and
a plurality of connection wirings arranged in the row direction at positions outside the image display region, for supplying the common voltage to the second common bus line, wherein:
the second common bus line comprises a plurality of division wirings; and
wiring resistances of the plurality of division wirings are substantially equal to each other in a region of from a connection portion between the plurality of division wirings and the first common bus line to a connection portion between the plurality of division wirings and the plurality of connection wirings.
